(19) United States
(12) Patent Application Publication
(10) Pub. No.: US 2005/0084688 A1
(43) Pub. Date: Apr. 21, 2005

(54) Treatment of organic pollution on an inorganic substrate

(75) Inventors: Ronan Garrec, Compiegne (FR); Noel Crux, Choisy au Bac (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SAINT-GOBAIN GLASS FRANCH, Courbevoie (FR)

(21) Appl. No.: 10/501,557

(22) PCT Filed: Jan. 22, 2003
(86) PCT No.: PCT/FR03/00201

(30) Foreign Application Priority Data
Jan. 25, 2002 (FR) 02/01387

(51) Int. Cl. B05D 3/08; B32B 17/06

(52) U.S. Cl. 428/432; 427/532; 427/558; 427/224; 428/426

(57) ABSTRACT

The invention relates to a method of treating organic pollution on a substrate made of glass, oxide or any other essentially mineral or metallic material, exhibiting a functionality by the fact that it consists of one or more stacked layers and/or by the fact that it exhibits a particular surface morphology. This method is distinguished by the fact that it consists of an electrical treatment, an ozone UV treatment or a flame treatment, optionally followed by a washing operation. The invention also relates to devices for implementing this method, to the application of this method to hydrophilic and/or oleophilic glazing, and to glazing treated by this method and intended for a transport vehicle, for a building, for urban furniture, for an indoor or outdoor decorative element or for domestic electrical appliances.

The present invention relates to the treatment of organic pollution on an inorganic substrate, especially of the type exhibiting a functionality by the fact that it consists of one or more stacked layers, each possibly having a thickness as low as 10 nm for example, and/or by the fact that it has a particular surface morphology.

The inorganic substrate consists of a metal, a metal alloy, a ceramic, a glass, an oxide or essentially mineral material, especially, in the latter two cases, in the form of thin-film coatings. The invention is particularly beneficial when the substrate is transparent and requires a high optical quality, whether this is a substrate made of glass or made of glass provided with one or more functional coating layers.

A soda-lime glass, especially a float glass such as that used for transport vehicles, for buildings or other applications of flat glass, or a glass of the bottle or flask type, a borosilicate of the Pyrex type, a phosphate glass that can be used as prosthesis or optical glass, a lead (crystal) glass, an aluminosilicate, such as a glass-ceramic, or an amorphous solid material containing no silica, may be employed.

As functional layers coating the glass in a known manner, mention may be made of low-emissivity layers, solar-protection layers, antireflection coatings, decorative layers (for example those that are acid-frosted, screen-printed, lacquered, enameled, textured by rolling between rollers or by other equivalent processes), or hydrophobic and/or oleophobic or hydrophilic and/or oleophilic layers, it being possible for certain of these not to be on the 1 face of the glazing units, that is to say by convention that face intended to be in contact with the external atmosphere (and not with the atmosphere of a building enclosure or a vehicle, for example). Certain of these layers are described in applications WO 02/02472, WO 97/10186, WO 97/10185 and WO 01/32578 incorporated here by way of reference.

There are diverse sources of organic pollution; mention may be made of hydrocarbons coming from the exhaust gases of transport vehicles, or various combustion products in suspension in the atmosphere, or more localized sources. The silicone used around the periphery of multiple glazing units or used as sealant for glazing in window fillisters or door rebates therefore prove to have a very great tendency to migrate, so that a region of the glazing up to a distance of 15 to 20 cm from the edge can be polluted. Polysulfide and neoprene, which may also form part of the construction of glazing, especially multiple glazing units, or used to fit them into window and door frames, are also potential sources of pollution.

Now, the formation of organic pollution on a substrate of the abovementioned type may degrade the desired performance of the substrate. In the case of a substrate with a very sensitive functionality, the organic pollution is capable of forming a screen; it forms relatively tenacious traces and reduces the quality of visibility through a transparent substrate.

Moreover, when the substrate consists of layers as thin as mentioned above, or is textured with features having dimensions of the order of 10 to 200 nm, the problem arises of finding a means of eliminating the negative effects of the organic pollution without destroying the substrate, but on the contrary preserving its surface morphology as the case may be and restoring its initial function as regards its quality and its durability, to the level that it had before formation of the pollution.

For this purpose, the subject of the invention is a method of treating organic pollution on a substrate made of glass, oxide or any other essentially mineral or metallic material, exhibiting a functionality by the fact that it consists of one or more stacked layers and/or by the fact that it exhibits a particular surface morphology, characterized in that it consists of an electrical treatment, an ozone UV treatment or a flame treatment, optionally followed by a washing operation. This method proves to be suitable for eliminating any effect of an organic pollution, so as to regenerate various substrates to their states prior to the formation of the pollution, without any apparent weakening of the substrate resulting therefrom, and without destroying the surface morphologies, even those with the finest features (texturing).

In one particularly practical embodiment of the invention, said electrical treatment is chosen from treatments of the corona discharge type, a vacuum or atmospheric-pressure plasma treatment, or the action of an electric field.

In one application, said substrate is hydrophilic and/or oleophilic. In fact, an organic pollution in general imparts a pronounced hydrophobic character to the substrate on which it is deposited, while adhering strongly thereto, so that it is difficult to detach it therefrom. This particular difficulty can be overcome thanks to the invention, for the purpose of restoring the initial hydrophilicity and/or oleophilicity. In this way of implementing the present method, two main variants can be distinguished.

According to a first variant, said substrate comprises a layer based on an at least partly oxidized silicon derivative chosen from silicon dioxide or oxygen-deplete substoichiometric oxides of silicon, silicon oxycarbide or silicon oxynitride. This layer, deposited by a sol-gel technique or by pyrolysis, especially by CVD (chemical vapor deposition), is described in application WO 01/32578 and is distinguished by a low angle of contact with water, thus promoting the formation of a thin liquid film that does not impair vision, especially through glazing, which prevents the formation of condensation droplets, and also by a surface geometry in the form of globes providing a capillary effect. This substrate is noteworthy as regards its water-cleaning property, that is to say its ability to encompass and entrain any dirt in the thin uniform liquid film. On the other hand, an organic pollution that is relatively tenacious and/or in a relatively large amount will have to be removed, preferably without destroying the globular surface morphology, something that the method of the invention permits.

A second variant of the preferred implementation consists in that said substrate comprises a layer of titanium oxide at least partly crystallized in the form of anatase, in the form of rutile or in the form of an anatase/rutile mixture. This layer, obtained from at least one titanium precursor, where appropriate in solution, by liquid phase pyrolysis, by a sol-gel technique or else by chemical vapor deposition, is known in particular from applications WO 97/10185, WO 97/10186 and WO 99/44954. It is hydrophilic after exposure to light and is capable of degrading dirt of organic origin by a radical oxidation process. However, it is suitable, in this variant also, for eliminating tenacious organic pollution or organic pollution in large amounts and capable of forming a screen between the light and the TiO₂ layer, inactivating the latter.

The subject of the invention is also a device for implementing the method described above on a single or multiple glazing unit comprising monolithic or laminated glass. This device is:
either installed in proximity to the glazing manufacturing line or integrated into the latter;
or capable of being activated on the site where the glazing is installed, provided that the site has available a source of energy, unless the device is autonomous as regards energy.

A treatment of the corona discharge type in particular makes each of these two options possible, in particular by using relatively lightweight and small appliances, that are portable and operate by simply being connected to the mains.

Advantageously, a device for implementing the above method comprises a terminal tool that can be moved over the surface of the substrate or in proximity thereto, especially glazing.

Another subject of the invention consists in the application of the above-mentioned method to a single or multiple glazing unit comprising monolithic or laminated glass, and in which said substrate comprises a layer based on an at least partly oxidized derivative of silicon chosen from silicon dioxide or oxygen-deplete substoichiometric oxides of silicon, silicon oxycarbide or silicon oxynitride, and/or a layer containing TiO₂.

Another subject of the invention is a single or multiple glazing unit comprising monolithic or laminated glass, which has been subjected to the above treatment method and is intended for an air, water or land transport vehicle, in particular for a motor vehicle, for a building (window, door, sanitaryware or any other element such as a shower cubicle, table, tray, etc.), for urban furniture (bus shelter, etc.), for an interior decorative element such as an aquarium or an outdoor decorative element, or for domestic electrical appliances (oven door, refrigerator tray, etc.).

The invention will now be illustrated by the following implementation examples.

### EXAMPLE 1

Sheets of soda-lime-silica float glass were joined together in pairs, in a known manner, to form double glazing units, by bonding a hollow metal strip between the sheets and using a silicone sealing mastic in the peripheral groove.

Some of the glazing units thus formed were treated by corona discharge using an apparatus built into the assembly line. This apparatus comprised treatment heads, each formed by an anode/cathode pair connected to the mains and positioned at a distance of 0.5 to 2 cm from the surface to be treated, in a plane parallel thereto. An electric field was created between each anode and the 10 corresponding cathode, and air lying between the two was sprayed onto the glazing. Each treatment head was active for a glazing width of about 6 cm; several treatment heads could thus be positioned side by side depending on the width of glazing to be treated, all the treatment heads being moved simultaneously along the glazing.

The surfaces treated in this example consisted of an SiO₂ layer on one side and a silicon oxycarbide layer on the other side, with a thickness of 50 nm, these being formed using the teaching of the aforementioned application WO 01/32578.

The untreated glazing units exhibited traces in places in their peripheral region that affected the visibility up to about 20 cm from the edge. In contrast, the treated glazing units exhibited excellent quality, uniformity and durability of hydrophilicity that were identical to those of a control monolithic glass sheet coated with the same layer.

### EXAMPLE 2

Example 1 was repeated with glazing units differing only by the fact that the SiO₂ layer was coated with a 20 nm thick layer of photocatalytic TiO₂ formed using the teaching of applications WO 97/10185, WO 97/10186 and WO 99/44954.

The observations were identical to those of example 1.

### EXAMPLE 3

The glazing units of example 1 were fitted into openings in buildings, using silicone as sealant, and then treated using the same principle, but by means of a portable appliance.

The observations were identical to those of example 1.

### EXAMPLE 4

Double glazing units identical to those of example 1 were treated by a propane/oxygen flame. The burner was positioned at a distance of 4 to 5 cm from the surface to be treated and adjusted so that the flames simply licked the glass so that the latter was quite hot on the surface, but not hot through the depth. Simple washing with distilled water restored hydrophilicity as lasting as, and of quality identical to, that exhibited by the control monolithic sheet.

1-10. (canceled)

11. A method of treating organic pollution comprising:
treating a substrate with an electrical treatment, an ozone UV radiation, or a flame; then
optionally washing said substrate;
wherein said substrate comprises
a material selected from the group consisting of glass, oxide, mineral, metallic material and mixtures thereof,
one or more stacked layers, and/or
a particular surface morphology.

12. The method as claimed in claim 1, wherein said electrical treatment is selected from the group consisting of a corona discharge type, a plasma, an electric field and combinations thereof.

13. The method as claimed in claim 1, wherein said substrate is hydrophilic and/or oleophilic.

14. The method as claimed in claim 3, wherein said substrate comprises a layer which comprises at least partly oxidized derivative of silicon selected from the group consisting of silicon dioxide, oxygen-depleted substoichiometric oxides of silicon, silicon oxycarbide, silicon oxynitride and mixtures thereof.

15. The method as claimed in claim 3, wherein said substrate comprises a layer of titanium oxide at least partly crystallized in the form of anatase, rutile or anatase/rutile mixture.

16. A device capable of treating organic pollution as claimed in claim 1, wherein said substrate comprises a single or multiple glazing unit comprising monolithic or laminated glass, wherein said device is installed in proximity to or integrated into a glazing manufacturing line.

17. A device capable of treating organic pollution as claimed in claim 1, wherein
said substrate comprises a single or multiple glazing unit comprising monolithic or laminated glass, and
said device is capable of being activated on the site where the single or multiple glazing unit is installed.

18. A device capable of treating organic pollution as claimed in claim 1, wherein said device comprises a terminal tool that can be moved over the surface of the substrate, or in proximity to said surface of the substrate.

19. The method as claimed in claim 1, wherein
said substrate comprises to a single or multiple glazing unit comprising monolithic or laminated glass, and
a layer which comprises at least partly oxidized derivative of silicon selected from the group consisting of silicon dioxide, oxygen-depleted substoichiometric oxides of silicon, silicon oxycarbide, silicon oxynitride and mixtures thereof, and/or
a layer comprising TiO₂.

20. A single or multiple glazing unit comprising monolithic or laminated glass, wherein said single or multiple glazing unit has been subjected to the treatment method of claim 1.
